(19) United States
(12) Patent Application Publication
(10) Pub. No.: US 2002/0120652 A1
(43) Pub. Date: Aug. 29, 2002

(54) Two-stage mapping for application specific markup and binary encoding

(76) Inventors: Hawley K. Rising III, San Jose, CA (US); Ali J. Tabatabai, Cupertino, CA (US); Mohammed Zubair Visharam, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/044,861

(22) Filed: Oct. 22, 2001

Related U.S. Application Data
(63) Continuation-in-part of application No. 09/904,271, filed on Jul. 11, 2001.
(60) Provisional application No. 60/242,278, filed on Oct. 20, 2000.

(51) Int. Cl. G06F 17/00

(52) U.S. Cl. 707/513

(57) ABSTRACT

Multimedia content descriptions are encoded for a specific application domain using an instance document that encodes the descriptions in a general application domain. The instance document is transformed from the general application domain to the specific application domain by mapping from a general application namespace to a specific application namespace, and a binary version is created from the transformed instance document. A frequency table derived from the specific application namespace may be used to create a more optimized binary version.

### RELATED APPLICATIONS

The present application claims the benefit of U.S. Provisional application serial number 60/242,278 filed on Oct. 20, 2000, which is herein incorporated by reference, and is a continuation in part of U.S. application Ser. No. 09/904,271, filed on Jul. 11, 2001.

### FIELD OF THE INVENTION

This invention relates generally to multimedia content descriptions and more particularly to transforming and encoding such descriptions of multimedia content.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2000, Sony Electronics, Inc., All Rights Reserved.

### BACKGROUND OF THE INVENTION

Digital multimedia content is becoming widely distributed through broadcast transmission, such as digital television signals, and interactive transmission, such as the Internet. The content may be still images, audio feeds, or video data streams. However, the enthusiasm for developing multimedia content has led to increasing difficulties in managing, accessing and identifying such a large volume of content. Furthermore, complexity and a lack of adequate indexing standards are problematic.

The Moving Picture Experts Group (MPEG) has promulgated a Multimedia Content Description Interface standard, commonly referred to as MPEG-7, to standardize the description of multimedia content when it is transmitted from a system that generates the content to a system that presents the content to a user. In contrast to preceding MPEG standards such as MPEG-1 and MPEG-2, which relate to coded representation of audio-visual content, MPEG-7 is directed toward representing and describing information relating to the content, and not the content itself. The MPEG-7 standard seeks to provide a rich set of standardized tools for describing multimedia content, with the objective of providing a single standard for creating interoperable, simple and flexible solutions for indexing, searching and retrieving multimedia content.

More specifically, MPEG-7 defines and standardizes a core set of “descriptors” for describing the various features of multimedia content; “description schemes” for describing relationships among the descriptors, the descriptors and other description schemes, and among description schemes; and a “description definition language” (DDL) for defining the description schemes and descriptors. The descriptions and description schemes for a particular type of multimedia content are encoded into a DDL-based schema. Each descriptor entry in the schema specifies the syntax and semantics of the corresponding feature. Each description scheme entry in the schema specifies the structure and semantics of the relationships among its children components.

For example, a standard movie includes scenes, shots within scenes, titles for scenes, and time, color, shape, motion, and audio for shots. The corresponding schema would contain descriptors that describe the features of the content, such as color, shape, motion, audio, title, etc., and one or more description schemes, e.g., a shot description scheme that relates the features of a shot, and a scene description scheme that relates the different shots in a scene and relates the title of the scene to the shots.

The DDL for MPEG-7 multimedia content is based on the XML (extensible markup language) standard. The descriptors, description schemes, semantics, syntax, and structures of the content description are coded as XML markup elements. XML attributes can be used to specify additional information about the markup elements. Some of the markup elements and attributes may be optional.

An instance of a content description, such as a particular movie, is specified in an XML “instance document” that incorporates the appropriate DDL-based schema and contains a set of “descriptor values” for the required elements and attributes in the schema, and for any necessary optional elements and/or attributes. The instance document is transmitted by a server across a network to a client application that presents the multimedia content described in the instance document. An instance document is typically encoded into a binary form (“binarization”) to reduce the amount of network bandwidth necessary to transmit the instance document.

In MPEG-7, specific descriptors are defined for audio content and video features. Multimedia description schemes (MDS) provide a set of standardized descriptor and description scheme markup elements as description tools that can be applied to any type of content. For example, there are description tools for retrieving images and video by color, tools for decomposing video into scenes and shots, and tools for giving semantic explanations. The MDS description tools can be extended to create a variety of customized applications.

The existence of clients with different device capabilities, and which are coupled over a variety of heterogeneous networks, has motivated the creation of special markup elements optimized for specific applications. For example, the Wireless Application Protocol (WAP) Forum has designed WML (Wireless Markup Language), which is a subset of XML that is optimized for the unique constraints of the wireless environment, e.g., screen size, low resolution, low CPU power, small memory, high latency and intermittent coverage. WML includes a new markup element called “card” to allow media presentation on the limited size screen that is characteristic of mobile devices. In addition, given the low transmission bandwidth, WAP utilizes binary transmission to achieve greater compression of data.

Each new application domain must either be separately standardized, which may take a year or more, or use the markup elements of existing, standardized domains, resulting in inefficient transmission. Additionally, the existing standardized domains may be unnecessarily limited in trying to meet the needs of small application domains, and thus may not implement advanced features.

### SUMMARY OF THE INVENTION

Multimedia content descriptions are encoded for a specific application domain using an instance document that encodes the descriptions of multimedia content in a general application domain. The instance document is transformed from the general application domain to the specific application domain by mapping from a general application namespace to a specific application namespace, and a binary version is created from the transformed instance document. A frequency table derived from the specific application namespace may be used to create a more optimized binary version.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIGS. 1A-B are diagrams illustrating encoding of an MPEG-7 instance document according to embodiments of the invention;

FIG. 1C is a diagram illustrating a communication network for standardization of MPEG-7 among different domains and for optimizing MPEG-7 transmissions between the domains;

FIG. 1D is a diagram of a computer environment suitable for practicing the invention;

FIG. 2A is a flow diagram of a method to encode an instance document as shown in FIGS. 1A-B; and

FIG. 2B is a flow diagram of a method for standardization of MPEG-7 among different domains and for optimizing MPEG-7 transmissions between the domains as shown in FIG. 1C.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

As used herein, the term “application specific” means either a single application domain or a group of application domains that have similar or close characteristics, as is traditional within the MPEG standard when defining profiles. Examples of such requirements are small specialized hardware, such as stock-reading consumer electronic devices, professional editing equipment that needs very large descriptions, computer game devices that require only the transmission of simplified game scenarios, and mobile devices with low bandwidth.

As a result of defining a new application specific domain, new markup languages, called henceforth ADLs or ASDLs (Application Specific Description Languages) need to be developed. An ASDL is a subset of the standard MPEG-7 DDL in that it contains a limited number of the DDL elements. For example, implementing a simple semantic description for multimedia content in MPEG-7 using the standard MPEG-7 DDL could require that a compatible decoder be able to interpret seventy-five or more description schemes. If a specific domain was defined to be audio-only, a corresponding ASDL could be written to exclude standard elements that are not required for a purely audio description of, for example, a movie, resulting in a smaller decoder venue. When frequency tables are used to generate the codes for binarizing the instance document, a frequency table for the audio-only content could be created based only on the frequencies of the audio elements in the ASDL so that the ASDL binarization would therefore be more efficient. In addition, an ASDL may define its own application specific markups and structures for visualization, summary, browsing, scripting, etc., which could reduce the size of the instance document prior to binarization.

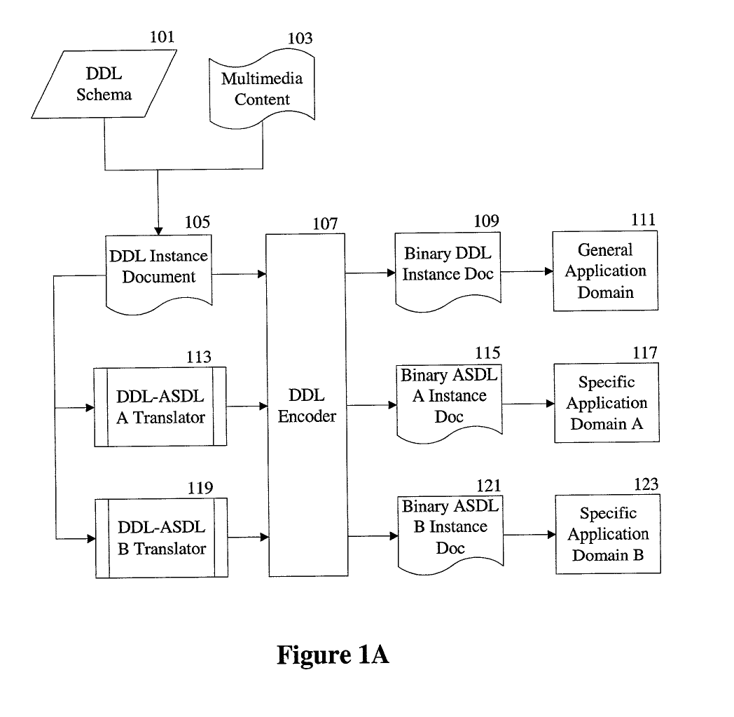

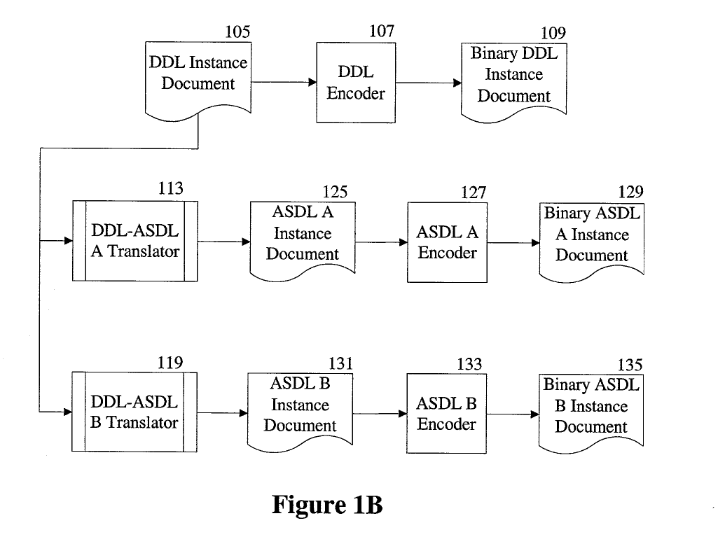

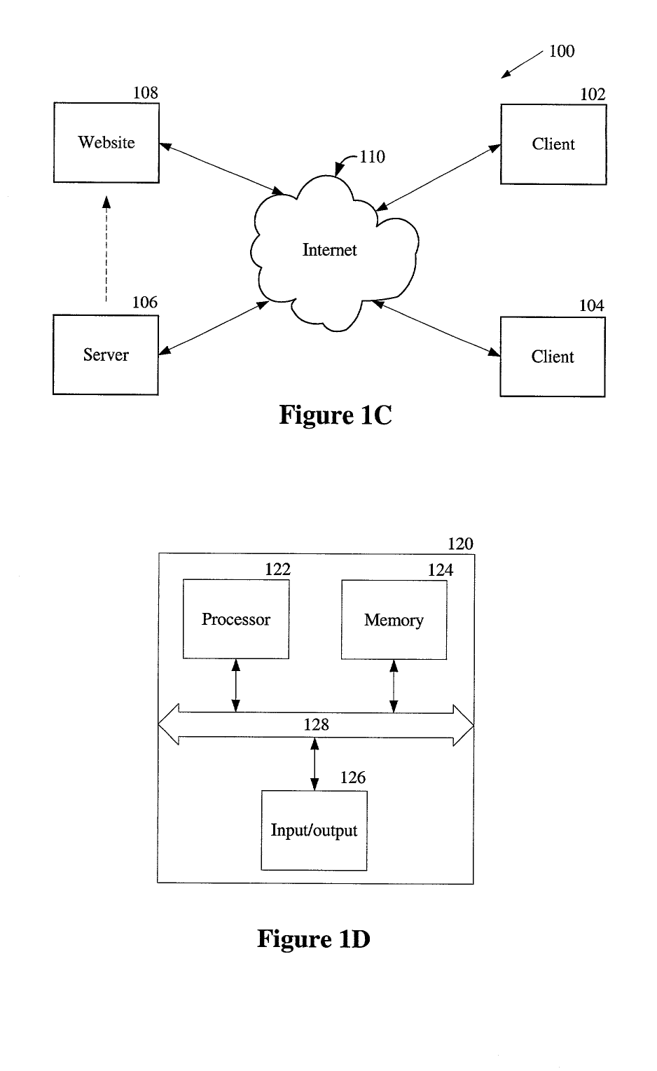

Instead of directly creating instance documents for each domain in which a content description could be used, embodiments illustrated in FIGS. 1A and 1B start with a DDL instance document 105 that encodes content 103 for use in a general application domain 111 as defined by DDL schema 101. In cases when the content 103 is to be used in a application specific domains A 117 or B 123, the instance document 105 likely contains unnecessary elements. Therefore, DDL to ASDL translators 113, 119 transform the DDL instance document 105 into instance documents specific to application domains A 117 and B 123, respectively. In one embodiment, the translators 113, 119 use transform functions defined in an XSLT (XML stylesheet translation) document that maps between DDL and ASDL namespaces.

Mapping between the schema namespaces could include passing a DDL element unchanged, changing it to a broader or narrower term, or dropping it altogether. In addition, some DDL elements might spawn ASDL elements that are not in the DDL schema, such as hints on how to display the description to a user. Because XSLT functions can translate between any text-based document, an ASDL may written in a language other than XML, depending on the requirements of the domain.

For example, assume application domain 117 is specific to “television anytime” (TVA) and application domain 123 is specific to mobile devices (MOB). Further assume DDL schema 101 contains a generic description scheme (DS) for content 103 consisting of a SegmentDS (TVA) and a SummarizationDS (MOB). Encoding the generic DS in an instance document would create an instance document that is not optimized for either the TVA or MOB domain. Using DDL to ASDL translator 113, 119 would map the portion of the DDL instance document corresponding to the SegmentDS (TVA) to the TVA instance document and the SummarizationDS(MOB) to the MOB instance document.

Typically, a text-to-binary entropy coding scheme is used to binarize an instance document. All entropy schemes have two parts: The model, which is expressed as frequency tables for the input elements, and the method, which could be Huffman coding (binary tree coding where the tree structure is governed by the frequency table) or Arithmetic coding (fractional coding where the spacing of the choices for the next digit are governed by the frequency table).

In the embodiment shown in FIG. 1A, a DDL encoder 107 uses a frequency table that associates the DDL namespace, i.e., the names for the elements and attributes, with variable-length codes or tokens based on the relative frequency with which the names appear within the DDL schema 101. In order to obtain the most compression, a frequency table assigns shorter codes to the more frequent names. Thus, encoding the DDL instance document 105 with a frequency table based on the DDL namespace provides the most efficient binarization for the general application domain 111.

In the embodiment shown in FIG. 1A, the same DDL encoder 107 is used to create binary instance documents 115, 121 for application specific domains A 117 and B 123. However, because the ASDL translators 113, 119 transform the instance document from a DDL namespace into an ASDL namespace, the DDL encoder 107 may not produce the most efficient binarization for the application specific domains A 117 and B 123. Thus, re-optimizing the frequency table over the smaller ASDL namespace may produce a more efficient text-to-binary coding scheme for each ASDL instance document. If the ASDL namespace represents a smaller symbol set because of the elimination of all description schemes, descriptors, attributes and elements not used by the specific application domain, the set of tokens (codes for names of tags, attributes, etc.) is correspondingly smaller, with the result that the entropy coder will generate shorter tokens. Additionally, because only the ASDL tools are encoded, an instance document for content descriptions created using an ASDL schema is optimized for the specific domain over an instance document for the same content created using the DDL schema.

Because the restriction of the ADLASDL symbol set is done in the markup language domain, the scheme is extensible, in that it would be possible to design only one binary encoding scheme, say Huffman or arithmetic encoding, and use it for many specialized markups, given the appropriate frequency tables as illustrated in FIG. 1B. The DDL encoder 107 is replaced by encoders 127, 133 that incorporate frequency tables based on the corresponding ASDL namespaces. The resulting binary ASDL instance documents 129, 135 are, in the majority of cases, more compressed than their counterparts 115, 121 that are encoded with DDL encoder 107.

The binary encoding can be fully one-to-one, because any loss of information due to application specific domain restrictions will be in the markup language domain. As in many lossy coding schemes, there is a lossy phase, and a lossless phase. If these are well differentiated, then the lossy phase is done first. In one embodiment, the lossy phrase prunes the input symbol set. The subsequent entropy phase, which is the binary phase, is lossless, hence one-to-one. Similarly, in the MPEG 1 or 2 domain there is a quantization phase in the DCT (discrete cosine transformation) encoding and motion encoding (which is lossy) followed by Huffman coding which is lossless.

A communication network 100 as illustrated in FIG. 1C is suitable for standardization of MPEG-7 multimedia content descriptions among different domains and for optimizing MPEG-7 content description transmissions between the domains. Among other components, communication network 100 comprises a provider or server 106 for the application domain entity (organization or company) that provides an application specific markup language, and clients 102, 104 that are users of the application domain. Server 106 generates a list of application specific requirements, which are used to create the application specific markup language. Server 106 may be provided by any individuals or organizations that have an interest in creating the domain, or informally by an individual with a website, or anything in between. A public, well-known address, such as a web site 108, that may or may not be served-up by server 106, publishes an XSLT document containing the transformation functions for mapping into the application specific markup language, and publishes the frequency tables for the ASDL namespace for access by the clients 102, 104 over a communication network 110, such as the Internet. Communication among the components is provided by the communication network 110.

The descriptions of a piece of multimedia content are encoded into a DDL instance document by the author or distributor of the content. An entity, such as server 106, transforms the DDL instance document into an appropriate ASDL instance document using the published XSLT document and binarizes the ASDL instance document using the published ASDL frequency tables. The resulting binary ASDL instance document is published on the web site 108 for transmission to the clients 102, 104 upon request. The clients 102, 104 use the published frequency tables to decode the binary ASDL instance document into its corresponding text form. A domain specific application executing on the clients 102, 104 re-creates the content from the ASDL instance document with reference to the ASDL schema. Alternately, a generic application, such as a browser, can re-create the content by using the XSLT document to transform the ASDL instance document back into the DDL namespace. It will be appreciated that the ASDL schema and decoder at the client may be integral parts of the domain specific application or may be plug-in modules obtained from, for example, web site 108, that allow the generic multimedia application to present the ASDL encoded content descriptions. Additionally, one of skill in the art will immediately recognize that the XSLT document, the frequency tables, and the binary ASDL instance document may be stored on different servers and web sites.

One embodiment of a computer system 120 suitable for use as the servers or clients of FIG. 1C is illustrated in FIG. 1D. The computer system 120, includes a processor 122, memory 124, and input/output capability 126 coupled to a system bus 128. The memory 124 is configured to store instructions which, when executed by the processor 122, perform the methods described herein. The memory 124 may also store data, such as the instance documents, XSLT documents, frequency tables, and schemas. Input/output 126 provides for the delivery and display of the content, content descriptions or portions or representations thereof, through, for example, networks, such as the Internet, and display devices such as computer or television monitors, and includes input/output devices such as a keyboard, digital image input, printer, scanner, mouse or other pointing device. Input/output 126 also encompasses various types of computer-readable media, including any type of storage device that is accessible by the processor 122. One of skill in the art will immediately recognize that the term “computer-readable medium/media” further encompasses a carrier wave that encodes a data signal. It will also be appreciated that the system 120 is controlled by operating system software executing in memory 124. Input/output and related media 126 may store the computer-executable instructions for the operating system and methods of the present invention as well as data.

The description of FIGS. 1C-D is intended to provide an overview of computer hardware and other operating components suitable for implementing the invention, but is not intended to limit the applicable environments. It will be appreciated that the computer system 120 is one example of many possible computer systems, which have different architectures. A typical computer system will usually include at least a processor, memory, and a bus coupling the memory to the processor. One of skill in the art will immediately appreciate that the invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices linked through a communications network.

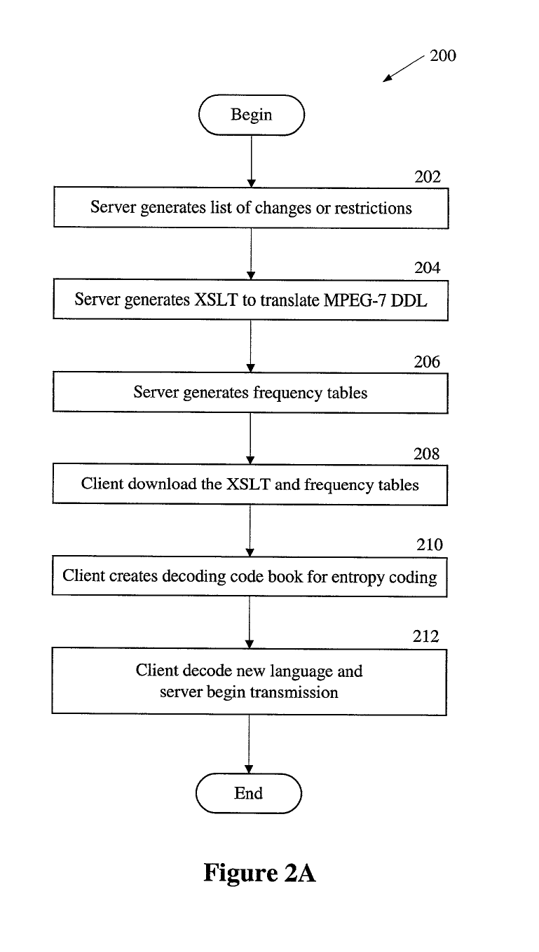

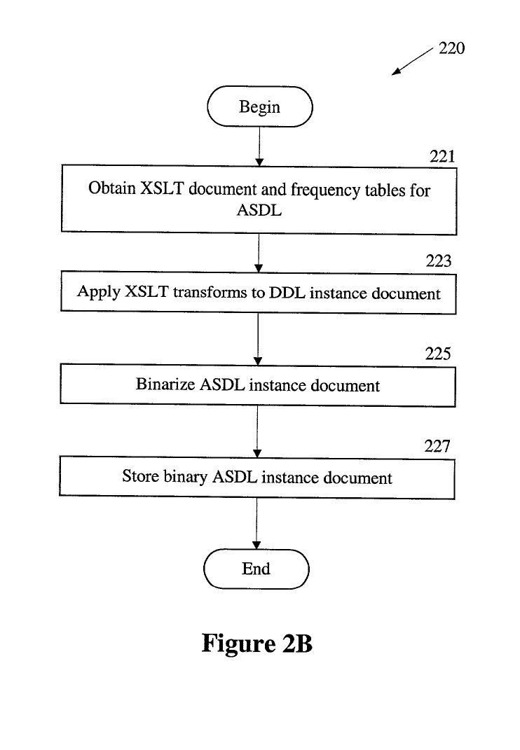

FIG. 2A illustrates an embodiment of a method 200 to be performed by computers acting as server 106 and client 102 in FIG. 1C. At block 202, server 106 generates the list of changes or restrictions to the standard MPEG-7 DDL that are needed to support the specific application domain. At block 204, server 106 generates an XSLT document to translate the MPEG-7 DDL namespace to the ASDL namespace based on the list generated at block 202. At block 206, server 106 generates frequency tables used to create the binary ASDL instance document. The frequency tables and XSLT document are subsequently provided to web site 108 (not illustrated).

At block 208, client 102 downloads the XSLT and frequency tables from the web site 108. At block 210, client 102 creates the decoding codebook corresponding to the entropy coding using the frequency tables. At block 212, client 102 can now decode the new language and the providers, i.e. server 106, may begin transmission of the binary ASDL instance document.

It should be observed that client 102 in one application domain can access the application domain of client 104 by translating back (via XSLT) to the full DDL, and through a second translation function to the other domain. Such embodiments, while not illustrated, are considered within the scope of the invention.

Turning now to FIG. 2B, an embodiment of a method 220 executed by a computer to create and encode an ASDL instance document is described. The XSLT document and frequency tables for the appropriate specific domain are obtained (block 221), such as from web site 108. The translation functions in the XSLT document are applied to a DDL instance document to create the ASDL instance document (block 223). The ASDL instance document is binarized using the frequency tables (block 225) and stored for subsequent transmission to a client (block 227). In an alternate embodiment, the frequency tables obtained at block 221 are optimized for the DDL domain, not the ASDL domain.

It will be appreciated that more or fewer processes may be incorporated into the method(s) illustrated in FIGS. 2A-B without departing from the scope of the invention and that no particular order is implied by the arrangement of blocks shown and described herein. It further will be appreciated that the method(s) described in conjunction with FIGS. 2A-B may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions, which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result.

Thus, the steps for encoding a DDL instance document are DDL→(XSLT)→ASDL→(entropy coder)→Binary. For some application domains the XSLT translation may be lossless (full descriptions allowed). Likewise, for application domains requiring fixed length codes (such as editing applications), the frequency table for the entropy coder has a uniform distribution. Consequently, many current and alternate schemes are implementable as special cases of this two-stage mapping scheme.

As mentioned above, the introduction of ASDL enables a two-staged approach for the text-to-binary encoding of content descriptions in a more efficient manner. DDL-based content descriptions are transformed into an ASDL namespace and the text-binary coding is optimized for the ASDL namespace. The binary coding is token based. Some tokens are application-specific while others can be global. To facilitate both DDL to ASDL translation, as well as binary encoding of the resulting ASDL instance document, one embodiment uses an MPEG-7 MarkupTranscodingHints DS with the following syntax:

<complexType name=“MarkupTranscodingHints”>

<attribute name=“id” type=“ID” use=“required”/>
<attribute name=“href” type=“uriReference” use=“optional”/>
<attribute name=“idref” type=“IDREF” refType=
“transformHints”/>
<element name=“TokenRef” minOccurs=“O”maxOccurs
“unbounded”>

<complexType>

<attribute name=“id” type=“ID” use=“required”/>
<attribute name=“href” type=“uriReference” use=
“optional”/>
<attribute name=“idref” type=“TDREF”

refType=“AttributeValuePair”/>

</complexType>

</element>

</complexType>

The syntax refers to the way the translation entity, as well as both local and global token tables, are used for binary encoding. Hints such as frequency tables for Huffman or Q (quantization) coder can also be included and published across applications. Other general guidelines for the design of a more efficient binary coding scheme are the use of a context-based approach, which enables overlapping code spaces. An example of such an approach is the design of two-state parser with element and attribute as its state. A more compact binary representation is implementable, if the frequency of occurrence of each token is taken into account in the design of (adaptive) Huffman codes.

Thus, the application description languages described herein provide a way to profile MPEG-7 tools for application specific domains. These ASDLs are designed to take into account the constraints and requirements of the applications they will be serving. Furthermore, the ASDLs enable a two-stage methodology for the binary encoding of application specific domain instance documents. This two-stage approach includes transform functions for translating between DDL and ASDL namespaces to create an ASDL instance document from a DDL instance document. Additionally, frequency tables based on the appropriate ASDL namespace can be used to binarize the ASDL instance document. Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention.

The terminology used in this application with respect to communication networks and computer environments is meant to include all of such networks and environments. Therefore, it is manifestly intended that this invention be limited only by the following claims and equivalents thereof.

What is claimed is:

1. A computerized method of encoding multimedia content descriptions for a specific application domain comprising:
obtaining an instance document that encodes the descriptions of multimedia content for a general application domain; and
transforming the instance document from the general application domain to the specific application domain by mapping from a general application namespace to a specific application namespace.

2. The computerized method of claim 1 further comprising:
creating a binary instance document from the transformed instance document.

3. The computerized method of claim 2 further comprising:
deriving a frequency table from the specific application namespace; and
using the frequency table to encode the binary instance document.

4. The computerized method of claim 1, wherein the specific application namespace includes elements in the general application namespace.

5. The computerized method of claim 1, wherein the general application namespace is defined by a data description language specified by MPEG-7.

6. The computerized method of claim 1, wherein the specific application namespace is defined by an application specific description language.

7. The computerized method of claim 1, wherein the mapping is defined in an extensible markup language stylesheet translation document.

8. A computer-readable medium having executable instructions to cause a computer to perform operations comprising:
obtaining an instance document that encodes descriptions of multimedia content for a general application domain; and
transforming the instance document from the general application domain to a specific application domain by mapping from a general application namespace to a specific application namespace.

9. The computer-readable medium of claim 8, wherein the operations further comprise:
creating a binary instance document from the transformed instance document.

10. The computer-readable medium of claim 9, wherein the operations further comprise:
deriving a frequency table from the specific application namespace; and
using the frequency table to encode the binary instance document.

11. A system to encode descriptions of multimedia content for a specific application domain comprising:
a processor coupled to a memory through a bus; and
an encoding process executed by the processor from the memory to cause the processor to obtain an instance document that encodes the descriptions of multimedia content for a general application domain, and to transform the instance document from the general application domain to the specific application domain by mapping from a general application namespace to a specific application namespace.

12. The system of claim 11, wherein the encoding process further causes the processor to create a binary instance document from the transformed instance document.

13. The system of claim 12, wherein the encoding process further causes the processor to derive a frequency table from the specific application namespace and to use the frequency table to encode the binary instance document.

14. A computerized method of presenting multimedia content descriptions on a client in a specific application domain, the method comprising:
transforming, by a server, an instance document from a general application domain to the specific application domain, wherein the instance document encodes the descriptions of multimedia content in the general application domain;
creating, by the server, a binary instance document from the transformed instance document; and
transmitting, by the server, the binary instance document to the client upon request from the client.

15. The computerized method of claim 14 further comprising:
receiving, by the client, the binary instance document from the server; and
recreating, by the client, the transformed instance document from the binary instance document.

16. The computerized method of claim 14, wherein transforming the instance document comprises:
mapping from a general application namespace to a specific application namespace.

17. The computerized method of claim 16 further comprising:
deriving, by the server, a frequency table from the specific application namespace; and
using, by the server, the frequency table to encode the binary instance document.

18. A computer-readable medium having executable instructions to cause a computer to perform operations comprising:
transforming an instance document from a general application domain to a specific application domain, the instance document encoding the descriptions of multimedia content in the general application domain;
creating a binary instance document from the transformed instance document; and
transmitting the binary instance document to a client upon request from the client.

19. The computer-readable medium of claim 18, wherein transforming the instance document comprises:
mapping from a general application namespace to a specific application namespace.

20. The computer-readable medium of claim 19, wherein the operations further comprise:
deriving a frequency table from the specific application namespace; and
using the frequency table to encode the binary instance document.

21. The computer-readable medium of claim 18, wherein the operations further comprise:
receiving the binary instance document; and
recreating the transformed instance document from the binary instance document.

22. A system to present multimedia content on a client in a specific application domain comprising:
a processor coupled to a memory through a bus; and
a server process executed from the memory by the processor to cause the processor to transform an instance document encoding descriptions of multimedia content in a general application domain from the general application domain to the specific application domain, to create a binary instance document from the transformed instance document, and to transmit the binary instance document to a client upon request from the client.

23. The system of claim 22, wherein the server process further causes the processor to map from a general application namespace to a specific application namespace to transform the instance document.

24. The system of claim 23, wherein the server process further causes the processor to derive a frequency table from the specific application namespace and to use the frequency table to encode the binary instance document.

25. The system of claim 22 further comprising:
a client process executed by the processor from the memory to cause the processor to receive the binary instance document and to recreate the transformed instance document from the binary instance document.

26. A computerized method of presenting multimedia content on a client in a specific application domain comprising:
receiving, by the client, a binary instance document; and
recreating, by the client, a transformed instance document from the binary instance document, wherein the transformed instance document encodes the descriptions of multimedia content in the specific application domain as a result of transforming an instance document that encodes the descriptions of multimedia content in a general application domain.

27. A computer-readable medium having executable instructions to cause a computer to perform operations comprising:
receiving a binary instance document; and
recreating a transformed instance document from the binary instance document, wherein the transformed instance document encodes descriptions of multimedia content in a specific application domain as a result of transforming an instance document that encodes the descriptions of multimedia content in a general application domain.

28. A system to present multimedia content on a client in a specific application domain comprising:
a processor coupled to a memory through a bus; and
a client process executed from the memory by the processor to cause the processor to receive a binary instance document and to recreate a transformed instance document from the binary instance document, wherein the transformed instance document encodes the descriptions of multimedia content in the specific application domain as a result of transforming an instance document that encodes the descriptions of multimedia content in a general application domain.
